(19) United States
(12) Patent Application Publication
(10) Pub. No.: US 2013/0086904 A1
(43) Pub. Date: Apr. 11, 2013

(54) Solar Thermal Power Plant

(71) Applicants: Dave Bent, Bridgend (GB); Keith Davies, Pontyclun (GB)

(72) Inventors: Dave Bent, Bridgend (GB); Keith Davies, Pontyclun (GB)

(21) Appl. No.: 13/641,766

(22) PCT Filed: Apr. 14, 2011
(86) PCT No.: PCT/GB2011/050742

§ 371 Date: Nov. 27, 2012

(30) Foreign Application Priority Data
Apr. 19, 2010 (GB) 1006497.0

(51) Int. Cl. F03G 6/00; F22G 1/06; F22D 1/00

(52) U.S. Cl. CPC F03G 6/00; F22D 1/003; F22G 1/06
USPC 60/641.8; 60/653; 122/412; 122/466

(57) ABSTRACT

There is disclosed a method of generating superheated steam for use in power generation. The method comprises: (a) preheating feed water to a temperature below its boiling point; (b) boiling the preheated feed water to produce steam; and (c) superheating the steam. The feed water is boiled by heat exchange with a heat transfer fluid which has been heated by heat collected in a first solar radiation absorption device. In addition, one or other or both of the preheating and superheating is carried out by direct heating in a further solar radiation absorption device or devices. The invention also relates to an apparatus for generating superheated steam for use in power generation. The apparatus comprises: (1) a superheated steam generating portion for generating superheated steam, comprising: (a) a preheater zone for preheating a feed water to a temperature below its boiling point; (b) a boiler zone downstream of the preheater zone for boiling the preheated feed water to produce steam; and (c) a superheater zone downstream of the boiler zone, for superheating the steam; and (2) a heat transfer fluid portion comprising a first solar radiation absorption device for heating a heat transfer fluid and being configured to transfer heat from the heated heat transfer fluid to the feed water in the boiler zone. One or other of the preheater zone and the superheater zone comprises a further solar radiation absorption device for direct heating of the feed water or the steam, or wherein each of the preheater zone and the superheater zone comprises a further solar radiation absorption device for direct heating respectively of the feed water and the steam.

This invention relates to a solar thermal power plant and to a method for operating a solar thermal power plant.

### BACKGROUND OF THE INVENTION

In a known solar plant system, a heat transfer fluid loop is used to collect the energy of the sun and raise superheated steam to drive a Rankine cycle power block. An example of such a system is disclosed in WO-A-2009/034577. Another example of such a system may be found in WO-A-2007/093474.

In another known configuration, superheated steam is raised directly in one or more solar absorption devices. Such a configuration is shown in EP-A-1890035 in which a parabolic trough collector is used for generating saturated or slightly superheated vapor, and a three dimensional solar collector having a heliostat field and a central tower is used to superheat the vapor generated in the parabolic trough collector.

FR-A-2450363 discloses an embodiment of a solar power plant in which water is raised to steam directly in solar collectors. The steam is superheated by thermal contact with a heated heat transfer fluid which has been heated in a tower solar collector. The superheated steam is used to drive a turbine.

### SUMMARY OF THE INVENTION

The present invention is an improvement over the known systems referred to above, and involves a combination of a heat transfer fluid loop for steam generation in which the heat transfer fluid is heated by heat collected in a first solar radiation absorption device with a feed water preheating stage and a steam superheating stage, where one or other or both of the preheating stage and the superheating stage are carried out by direct solar heating in a further solar radiation absorption device or devices. This combination improves thermal efficiency by matching the water enthalpy curve but without pinch, and removes the issues associated with two phase flow in direct steam generation systems. Plant capital cost may be reduced due to reduction in the heat transfer fluid loop size and power block complexity.

Thus, according to a first aspect of the present invention, there is provided a method of generating superheated steam for use in power generation, comprising:

(a) preheating feed water to a temperature below its boiling point;

(b) boiling the preheated feed water to produce steam; and

(c) superheating the steam;

wherein the feed water is boiled by heat exchange with a heat transfer fluid which has been heated by heat collected in a first solar radiation absorption device;

and wherein one or other or both of the preheating and superheating is carried out by direct heating in a further solar radiation absorption device or devices.

According to a second aspect of the invention, there is provided an apparatus for generating superheated steam for use in power generation, comprising:

(1) a superheated steam generating portion for generating superheated steam, comprising:
(a) a preheater zone for preheating a feed water to a temperature below its boiling point;
(b) a boiler zone downstream of the preheater zone for boiling the preheated feed water to produce steam; and
(c) a superheater zone downstream of the boiler zone, for superheating the steam; and

(2) a heat transfer fluid portion comprising a first solar radiation absorption device for heating a heat transfer fluid and being configured to transfer heat from the heated heat transfer fluid to the feed water in the boiler zone;

wherein one or other of the preheater zone and the superheater zone comprises a further solar radiation absorption device for direct heating of the feed water or the steam, or wherein each of the preheater zone and the superheater zone comprises a further solar radiation absorption device for direct heating respectively of the feed water and the steam.

The apparatus of this aspect of the invention may be used in a method of generating superheated steam for use in power generation, comprising:

(a) preheating feed water in the preheater zone to a temperature below its boiling point;

(b) boiling the preheated feed water in the boiler zone to produce steam; and

(c) superheating the steam in the superheater zone;

wherein the feed water is boiled in the boiler zone by heat exchange with the heat transfer fluid which has been heated by heat collected in the first solar radiation absorption device;

and wherein one or other or both of the preheating and superheating is carried out by direct heating in the further solar radiation absorption device or devices.

According to a third aspect of the invention, there is provided a method of power generation comprising:

generating superheated steam by a method in accordance with the first aspect of the present invention; and

supplying the superheated steam to a turbine for power generation.

According to a fourth aspect of the invention, there is provided a solar power plant comprising:

an apparatus for generating superheated steam according to the second aspect of the invention; and

a turbine configured to receive superheated steam from the apparatus for generating superheated steam and capable of power generation.

According to a fifth aspect of the invention, there is provided a method of operating a solar power plant according to the fourth aspect of the present invention, comprising:

heating a heat transfer fluid (HTF) in the first solar radiation absorption device of the heat transfer fluid portion;

generating superheated steam from a feed water in the superheated steam generating portion; and

supplying the superheated steam to the turbine for power generation;

wherein the superheated steam for supply to the turbine is generated from the feed water in at least three heating stages comprising:

(a) a preheating stage in which the feed water is preheated in the preheater zone to a temperature below its boiling point;

(b) a boiling stage in which the preheated feed water is boiled in the boiler zone to produce steam; and

(c) a superheating stage in which the steam is superheated in the superheater zone;

wherein the feed water is boiled in the boiler zone by heat exchange with the heat transfer fluid which has been heated by heat collected in the first solar radiation absorption device;

and wherein one or other or both of the preheating and superheating is carried out by direct heating in the further solar radiation absorption device or devices.

The invention may also be applied to other working fluids apart from water, in which case references herein to “feed water” refer to “working fluid liquid” and references to “steam” refer to “working fluid vapour”. The invention will however be described herein with reference to the feed water being water.

### BRIEF DESCRIPTION OF THE DRAWINGS

FIG. 1 is a schematic diagram of a solar thermal power plant in accordance with the present invention.

### DETAILED DESCRIPTION OF THE INVENTION

The apparatus of the present invention is an apparatus for generating superheated steam at least in part from solar radiation which is collected in solar radiation absorption devices. The superheated steam may be used for power generation in a manner which is well known.

The apparatus comprises a steam generating portion for generating superheated steam. The steam generating portion comprises:

(a) a preheater zone for preheating a feed water to a temperature below its boiling point;

(b) a boiler zone downstream of the preheater zone for boiling the preheated feed water to produce steam; and

(c) a superheater zone downstream of the boiler zone, for superheating the steam.

The preheater zone, the boiler zone and the superheater zone are in fluid communication with each other whereby the feed water may be flowed from the preheater zone to the boiler zone and the steam may be flowed from the boiler zone to the superheater zone.

The apparatus also comprises a heat transfer fluid portion which includes a first solar radiation absorption device for heating a heat transfer fluid. The apparatus is configured to allow transfer of heat from the heated heat transfer fluid to the feed water in the boiler zone.

One or other of the preheater zone and the superheater zone may comprise a further solar radiation absorption device for direct heating of the feed water or the steam. Alternatively, in an embodiment, each of the preheater zone and the superheater zone comprises a further solar radiation absorption device for direct heating respectively of the feed water and the steam.

By “direct heating” is meant that the respective fluid (liquid water or steam) is heated by direct contact with a heated element in the solar radiation absorption device as opposed to indirect heating, in which at least one heat transfer fluid is used to carry heat from a solar radiation absorption device and transfer the heat to the respective fluid (liquid water or steam) in a heat exchanger unit.

The expression “preheater zone” refers to a zone or zones of the steam generating portion in which the feed water is preheated. Typically, the preheater zone or zones are formed as zones of one or more dedicated preheater units, the or each of which has an inlet for admitting the feed water and an outlet for discharging the preheated feed water.

In an embodiment of the invention the preheater zone may comprise one or more solar radiation absorption device in which the feed water is directly heated to a temperature below its boiling point.

In another embodiment, the preheated water may be heated by heat transfer contact with a heated heat transfer fluid which has been heated by solar energy.

In another embodiment of the invention, the preheater zone may include a heater element which is heated by a non-solar means. For example, the heater element may be heated by heat generated by combustion of a hydrocarbonaceous fuel. The fuel may be a conventional fossil fuel or may be a biofuel or a biomass material. Alternatively, the heater element may be heated by residual heat from another facility.

The pressure of the liquid water supplied to the preheater zone may be at least 50 bar, and is normally less than 200 bar. Typically, the pressure of the liquid water is 75 to 140 bar. The temperature of the water supplied to the preheater zone will typically be the temperature of the condensed water from the condenser, and so for example may be in the range from 25 to 80° C., for example of the order of 50° C.

In the preheater zone, the feed water is preheated to a temperature below its boiling point, for supply to the boiler. Reference to the boiling point is a reference to the boiling point of the feed water at the respective pressure at which it is supplied to the boiler. For example, the feed water may be supplied to the boiler at a temperature which is less than 100° C. below the boiling point, or a temperature which is less than 50° C. below the boiling point, or a temperature which is less than 20° C. below the boiling point, or a temperature which is less than 10° C. below the boiling point, or a temperature which is less than 5° C. below the boiling point. In an embodiment, the feed water is supplied to the boiler at a temperature which is approximately 1-2° C. below the boiling point. By way of further example, where the feed water pressure is in the range of 75-140 bar, the feed water may be heated in the preheater zone to a temperature in the range of from 250 to 335° C.

The expression “boiler zone” refers to a zone or zones of the steam generating portion in which the feed water is boiled. Typically, the boiler zone is a zone of a boiler apparatus which has an inlet for admitting the preheated water and an outlet for discharging steam.

In the boiler zone, the preheated water is brought into heat transfer contact with the heat transfer fluid which has been heated in the heat transfer fluid portion. For example, at least one heat exchanger may be situated in the boiler zone for contact with the feed water in the boiler zone. The heated heat transfer fluid is flowed through the at least one heat exchanger, whereby heat is transferred from the heat transfer fluid to the feed water sufficient to boil the feed water and evolve steam.

The expression “superheater zone” refers to a zone or zones of the steam generating portion in which steam evolved in the boiler zone is superheated above the boiling point of the feed water from which the steam is generated. The superheater zone or zones may be formed as zones of one or more dedicated superheater units, the or each of which has an inlet for admitting steam generated in the boiler zone and an outlet for discharging superheated steam. For example, in an embodiment, the superheater zone may comprise one or more solar radiation absorption device in which the steam is directly heated by contact with a heater element in the solar radiation absorption device to superheat the steam. In another embodiment, the superheater zone may include a heater element which is heated by a non-solar means. For example, the heater element may be heated by heat generated by combustion of a hydrocarbonaceous fuel. The fuel may, for example, be a conventional fossil fuel or may be a biofuel or a biomass material. In a further embodiment, the superheater zone may comprise a combination of one or more solar radiation absorption devices and one or more non-solar heating devices, such as burners for combustion of fossil fuels or other materials. The devices may be arranged in series, such that initial superheating is conducted in the one or more solar radiation absorption devices and additional superheating is conducted in the one or more non-solar heating devices.

Examples of embodiments of the invention are as follows:

The feed water is heated in the preheater zone by direct contact with a heater element in a solar absorption device and the steam from the boiler zone is superheated in the superheating zone by direct contact with a heater element in a solar absorption device.

The feed water is heated in the preheater zone by direct contact with a heater element in a solar absorption device and the steam from the boiler zone is superheated in the superheating zone by heat transfer from a heat transfer fluid.

The feed water is heated in the preheater zone by direct contact with a heater element in a solar absorption device and the steam from the boiler zone is superheated in a first superheating zone by heat transfer from a heat transfer fluid, and further heated by direct contact with a heater element in a solar absorption device.

The transfer of heat from the heated HTF to the feed water may be accomplished by direct or indirect thermal contact between the heated HTF and the feed water, as for example in a heat exchange system. For example, the heated HTF may be brought into direct thermal contact with the feed water in the boiler via a suitable heat exchange system. Alternatively, heat transfer may be accomplished by indirect thermal contact between the heated HTF and the feed water, as for example by way of an auxiliary heat transfer fluid which receives heat from the heated HTF (in a suitable heat exchange system) and transfers it to the feed water in the boiler by way of a suitable heat exchange system. In such an alternative arrangement, the HTF which is heated in the solar absorption device in the heat transfer portion is not thermally contacted with the feed water in the boiler; instead, it is the auxiliary heat transfer fluid which contacts the feed water in the boiler. It is presently considered that this embodiment may be less efficient as some heat loss will inevitably result in the exchange of heat between the heated HTF and the auxiliary heat transfer fluid.

In the aforementioned heat exchange system, heat may be transferred between fluids by conduction or convection. Suitable heat exchange systems are known and may comprise one or more heat exchange units as well as suitable connecting circuitry and components.

In an embodiment of the invention, the steam may be at least partially superheated in a superheating zone by heat transferred from a heated HTF. This may be the same or different from the HTF used to boil the feed water in the boiler. In an embodiment, the same HTF that is used to boil the feed water is used to superheat the steam from the boiler zone. In this embodiment, the HTF may be flowed to make heat transfer contact with the steam before it makes heat transfer contact with the feed water. In this way, the HTF is at a higher temperature when it makes heat transfer contact with the steam compared with the temperature at which it makes heat transfer contact with the feed water in the boiler zone.

A feature of the embodiment in which the same heat transfer fluid is used to boil the feed water and to at least partially superheat the stem evolved in the boiler zone is that the superheating zone may be provided in close proximity to the boiler zone, so that steam evolved in the boiler zone is immediately contacted with the heat transfer fluid and superheated above its boiling point. In this way, the formation of droplets of water can be avoided immediately downstream of the boiler zone. For example, the steam may be superheated by at least 1° C., or may be superheated by at least 5° C., or may be superheated by at least 10° C., or may be superheated by at least 20° C., or may be superheated by at least 50° C. or may be superheated by at least 100° C. The degree of superheating may be selected based on the temperature of the heat transfer fluid and the degree of cooling of the heat transfer fluid which is consistent with the heat transfer fluid being able to perform the function of boiling the feed water in the boiler zone. For example, the degree of superheating may be controlled by controlling the rates of flow of the heat transfer fluid and the steam when in heat transfer contact with each other. Heat transfer fluids which have a relatively higher enthalpy per unit mass of fluid or which have a relatively higher maximum operating temperature, or both may be particularly suited for use in embodiments where the heat transfer fluid is used to at least partially superheat the stem evolved in the boiler. For example, a heat transfer fluid which has a relatively higher enthalpy per unit mass of fluid is capable of delivering more heat energy to the steam for superheating purposes for the same degree of cooling compared with a heat transfer fluid which has a relatively lower enthalpy per unit mass of fluid. A heat transfer fluid which has a relatively higher maximum operating temperature, for example 430° C., is capable of superheating the steam to a higher temperature compared with a heat transfer fluid which has a relatively lower maximum operating temperature, for example 400° C.

In embodiments of the invention in which the steam is partially superheated in a superheating zone, it may be further superheated in a superheating zone by direct heating in a solar radiation absorption device. This enables the steam to be superheated to a sufficiently high temperature to enable efficient power generation. For example, in the superheater zone, the steam may be superheated to a temperature in the range of 450 to 600° C., for a pressure in the range of 75 to 140 bar. It may be desirable to employ a combination of a solar radiation absorption device and a non-solar heating device, such as a burner for fossil fuels, biofuel or a biomass material, to superheat the steam in the superheater zone. In certain circumstances, it may be that the maximum achievable temperature using solar thermal energy is below the optimum temperature for turbine efficiency. Alternatively, if the optimum temperature can be achieved using solar technology, this may not represent the most efficient heating mechanism. For example, a tower solar heating device may be employed to superheat steam to the optimum temperature for turbine efficiency, which may for example be approximately 550° C. However, the final 60° C. of superheating using a solar tower can impose a very high cost, as with increasing temperatures a greater amount of heat is radiated back to the environment. Thus, it may be desirable to combine both solar and non solar heating means to achieve a desired superheating temperature. For example, the majority of the superheating may be achieved using a solar power tower, employing renewable energy resources, with fossil fuels or biomass only employed to achieve the final 60 to 80° C. of superheating. Any appropriate combination of solar and non solar devices may be employed to achieve the desired superheat temperature in the most efficient manner.

In embodiments of the invention, the superheated steam is condensed in the turbine and/or in a condenser associated with the turbine, to regenerate the feed water for recirculation to the vaporization stage (optionally after preheating in the third solar absorption device) and subsequently to the superheating stage. In this embodiment, the vapor generating portion is typically in a fluid circuit with the turbine, and the feed water is repeatedly regenerated, transformed to the superheated vapor state and supplied to the turbine for power generation. This is the arrangement of a typical Rankine cycle power block. This fluid circuit may be formed of a network of pipes, tubes, or other passage forming components, and may include additional components such as reservoirs, valves and other devices for accommodating and controlling the flow of the fluid in the circuit. For example, a pump or pumps may be provided in the fluid circuit for fluidly circulating fluid in the circuit. Valves or other flow regulating devices may be provided to control the flow of fluid in the circuit.

The fluid circuit is typically a closed circuit, although provision may be made for topping up the feed water in the circuit.

The feed water is typically pressurized relative to atmospheric pressure over at least part of the vapor generating portion. For example, the feed water may be pressurized prior to supply to the preheater zone, and then maintained under pressure upstream of the boiler for supply of the superheated steam under pressure to the turbine.

In the turbine the pressure of the vapor is at least partially released, and the vapor may at least partially condense. One or more condenser may be provided in which the vapor from the turbine is condensed to fluid. The liquid immediately downstream of the turbine (and any condenser unit associated with the turbine) is at a low pressure (for example sub-atmospheric pressure) compared to pressure of the feed water for supply to the preheater zone, and so a pump, or other pressurizing device, may be provided to pressurize the feed water for supply to the preheater zone.

In embodiments of the invention, more than one turbine may be provided, in series or in parallel.

The turbine may be used to generate electricity in an electrical generator coupled to the turbine, in a manner which is well known.

In an embodiment, the heat transfer fluid portion may be a fluid circuit in which the HTF is circulated through the solar absorption device to heat the HTF. Downstream of the solar absorption device, the fluid circuit intersects with the boiler zone in the vapor generating portion where heat is transferred from the heated HTF to the feed water to form steam. Typically, one or more heat exchanger may be provided for transfer of heat from the heated HTF to the feed water. In the heat exchanger, the heated HTF is cooled and the feed water is heated to a temperature at which is vaporized. The cooled HTF is then returned in the fluid circuit to be reheated in the solar absorption device. The fluid circuit is typically closed, although provision may be made for topping up the HTF in the circuit if necessary.

The HTF fluid circuit may be formed of a network of pipes, tubes, or other passage forming components, and may include additional components such as reservoirs, valves and other devices for accommodating and controlling the flow of the HTF in the circuit. For example, a pump or pumps may be provided in the fluid circuit for fluidly circulating the HTF in the circuit. Valves or other flow regulating devices may be provided to control the flow of fluid in the circuit.

In embodiments, the HTF may be pressurized relative to atmospheric pressure over at least part of the HTF portion to prevent boiling of the HTF in the solar absorption device. Because of pressure losses in the heat transfer fluid circuit, in embodiments, a pump, or other pressurizing device may be provided downstream of the boiler to pressurize the HTF before supply to the solar absorption device.

Any suitable heat transfer fluid may be used in the present invention. Typical heat transfer fluids include oils which are stable at the desired temperatures. The heat transfer fluid may have a maximum operating temperature (typically the temperature at which the heat transfer fluid is stable) of at least 300° C., or at least 350° C., or at least 400° C. or at least 430° C. The heat transfer fluid may have a freezing point below 20° C., or below 10° C. or below 0° C. or below −10° C. or below −20° C. An example of a suitable heat transfer fluid is Dowtherm A, which is a synthetic organic heat transfer liquid, operable under pressure at temperatures up to about 400° C. Examples of other heat transfer fluids are silicone oils, Therminol and ethylene glycol.

The solar absorption devices used in the different stages of the invention may be the same or different between stages. Typically, a solar absorption device comprises a solar collector that is configured to collect solar energy and a receiver configured to receive solar energy reflected from the collector. Fluid is heated in the receiver by contact with a heater element, for example in a passage defined in the receiver, the walls of which are heated by the solar energy from the collector.

One type of solar absorption device which may be used in the present invention is a trough solar absorption device, as for example described in U.S. Pat. No. 7,296,410, the content of which is incorporated herein in its entirety by reference. As described in U.S. Pat. No. 7,296,410, a trough solar absorption device is configured to collect solar energy and reflect the solar energy to be absorbed by the fluid. The trough device may include a receiver that defines a passage for receiving the fluid as the fluid is circulated. The trough device also includes a solar collector that is configured to direct solar radiation toward the receiver to heat the fluid therein. For example, the solar collector can include one or more mirrors, such as parabolic mirrors, that reflect light from the sun toward the receivers. The solar collectors can be adjustable in position and configuration so that the solar collectors can follow the sun during the sun's relative movement so that solar energy from the sun is reflected toward the receivers regardless of the relative position of the sun. For example, each solar collector can be rotatably mounted on a stationary base or other structure and rotatably adjusted by one or more motors or other actuation devices in response to a detector or sensor that tracks the relative position of the sun. Alternatively, the solar collectors can be adjusted according to a pre-programmed algorithm or otherwise predetermined schedule.

Further, as described in U.S. Pat. No. 7,296,410, the trough device can include other types of solar collectors. For example, the solar collectors can include a lens, such as a Fresnel lens, in addition or alternative to the parabolic mirror. Further, each solar collector can include secondary parabolic mirrors, and the secondary parabolic mirrors and/or the lenses can be configured to heat the receivers at varying rates for preheating the receivers before the fluid is circulated. Solar collection devices that include multiple mirrors, lenses, and combinations of mirrors and lenses are described further in U.S. Pat. No. 7,055,519, the content of which is incorporated herein in its entirety by reference.

A second type of solar absorption device which may be used in the present invention is a linear Fresnel reflector which uses plane mirror strips to concentrate light onto the receiver with the fluid to be heated. Such devices are less expensive than parabolic trough devices.

A third type of solar absorption device is a tower solar absorption device (“power tower”), as described in U.S. Pat. No. 7,296,410. Such devices are also known as “heliostats”. As described in U.S. Pat. No. 7,296,410, a tower solar absorption device includes a tube-type receiver, which can be formed of a tube, reservoir, or other conduit defining a passage for receiving and circulating the fluid. The receiver is supported by an elevated tower structure. The tower solar absorption device also includes at least one solar collector configured to direct solar radiation toward the receiver. For example, the solar collectors can be heliostats arranged proximate to the tower structure. Hundreds or thousands of heliostats or other collectors can be positioned to reflect solar radiation for heating fluid in the tower device. Each heliostat can include a planar or curved mirror for reflecting solar radiation toward the receiver in the tower device, and each heliostat can be independently adjustable in response to the relative position of the sun. For example, the heliostats can be arranged in arrays, the heliostats of each array being controlled separately or in combination with the other heliostats of the array by one or more control devices configured to detect and track the relative position of the sun. Thus, the heliostats can adjust according to the position of the sun to reflect sunlight onto the receiver, thereby warming the fluid in the receiver.

In embodiments of the present invention, the solar absorption device for heating the heat transfer fluid may be a trough solar absorption device, preferably a parabolic trough, and the solar absorption device for superheating the steam may be a tower solar absorption device or a parabolic trough or a plane mirror device.

In embodiments where the feed water is preheated in a solar absorption device, a Fresnel reflector may be used, which is less expensive than parabolic trough and tower devices. Alternatively other solar absorption devices could be used, for example a trough type collector device. As the feed water is only to be heated to a temperature close to its boiling point, a lower cost trough type collector may be employed.

In each stage of the invention in which fluid is heated in a solar absorption device, it is to be understood that one or more solar absorption devices, which may be the same or different, may be employed, in series or in parallel.

In embodiments of the power plant of the invention, the heat transfer fluid portion may include a heat storage portion adapted to receive and store thermal energy from the heated heat transfer fluid. In particular, it is sometimes the case that the thermal energy of the heat transfer fluid is beyond what is required to achieve the vaporization (and optionally the partial superheating) of the feed water. This may occur at times of low demand or at times when the sun's radiant energy is at a peak. In order that the excess heat is not wasted, the heat transfer portion may include a branch portion which comprises a heat exchanger configured to exchange heat with a heat storage medium. The heat storage medium is typically a molten salt, but other heat storage materials may be used. In periods where excess heat is generated, the flow of heated HTF is diverted through the branch portion to the heat exchanger to give up heat and consequently heat the storage medium. The cooled HTF may then be supplied to the boiler where the remainder of its thermal energy is used to vaporize the feed water, as previously described.

At times where the thermal energy of the HTF is not sufficient for raising vapor in the boiler, this may be supplemented by thermal energy transferred from the heat storage medium. This may be achieved by providing a further branch in the heat transfer fluid portion whereby HTF is diverted to the heat exchanger for heat exchange with the heated heat storage medium. The resultant HTF, which has been heated by thermal contact with the heat storage medium, is then supplied to the boiler in a manner already described.

In this embodiment, suitable hot and cold storage tanks, connected by a suitable fluid connection via the heat exchanger may be provided for storage of the heat storage medium.

A supplementary non-solar heater may be provided to supply heat to the feed water when heating of the feed water in the superheater is insufficient. For example, a branch may be provided in the vapor generating portion bypassing the second solar absorption device, the branch including a furnace to superheat the vapor from the boiler for supply to the turbine. The furnace may be fuelled by any suitable fuel, such as gas, coal, oil, biomass, etc. Hot flue gas from the furnace may be directed to the steam boiler to provide ancillary heating in the boiler. Alternatively, or in addition, the hot flue gas may be directed to a suitable heat exchange system for preheating the feed water before supply to the boiler. As discussed above, it may be desirable to employ both the solar superheating device and the furnace in a series arrangement, in order to achieve the desired superheat temperature in the most efficient manner.

The power plant and the method of operating the power plant of the present invention may be controlled by a controller, such as a computer.

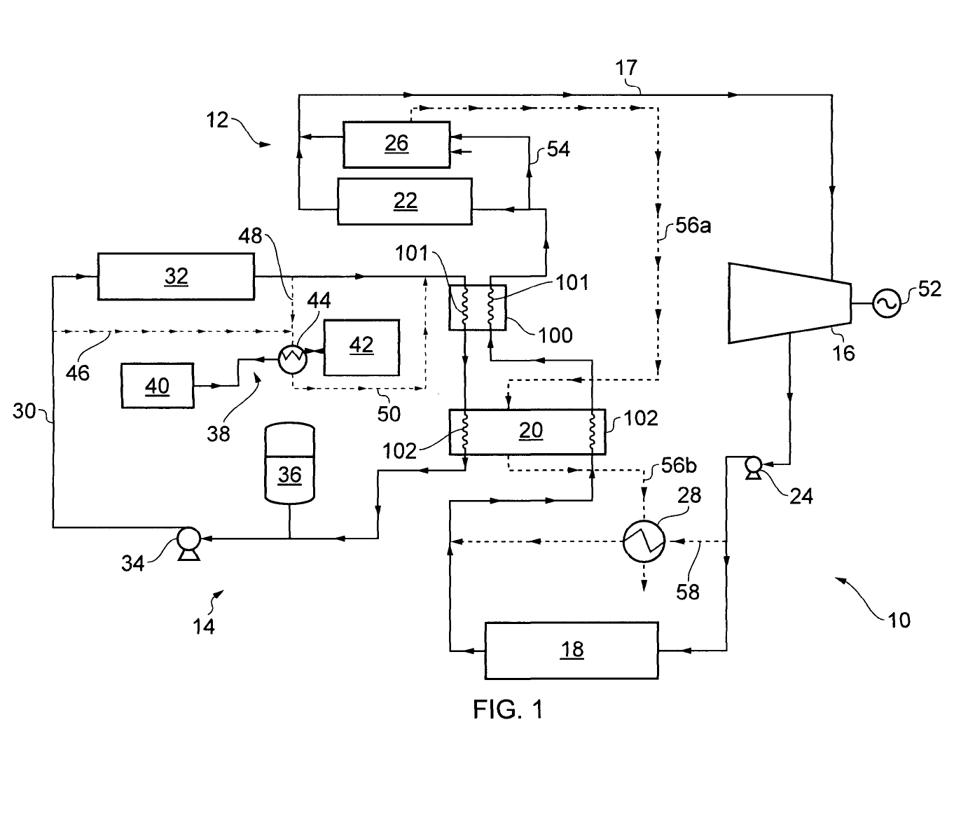

The invention will now be described, by way of example only by reference to FIG. 1.

A solar power plant 10 comprises a steam generating portion 12, a heat transfer fluid portion 14 and a condensing turbine 16. The steam generating portion 12 is fluidly connected with the turbine 16 in a fluid circuit 17 in which water and/or steam circulates to form a typical Rankine cycle power block.

The steam generating portion 12 comprises a boiler feed water (BFW) heater 18, a steam boiler 20, a first superheater 100 and a superheater 22. Additionally provided in the fluid circuit is a pressurizing pump 24.

Associated with the steam generating portion 12 is a supplementary superheat furnace 26 and a supplementary preheat device 28.

The heat transfer fluid portion 14 is in the form of a fluid circuit 30 for circulating a heat transfer fluid for thermal contact with steam in the first superheater 100 via heat transfer elements 101 and for subsequent contact in the steam boiler 20 with the boiler feed water via heat transfer elements 102. A solar absorption device 32 and a pressuring pump 34 are provided in the fluid circuit 30. Branching from the fluid circuit is a portion comprising an expansion tank 36.

Associated with the heat transfer fluid portion 14 is a heat storage medium circuit 38 which comprises a cold tank 40 and a hot tank 42 which are connected via a heat exchange unit 44. Flow passages 46, 48 and 50 are provided to flow heat transfer fluid from the fluid circuit 30 through the heat exchange unit 44.

The boiler feed water heater 18 comprises a solar absorption device which is configured to collect solar energy and transfer this energy to the boiler feed water which flows in the circuit 17 through the heater 18. For example, the solar absorption device used in this stage may be a linear Fresnel reflector.

The second superheater 22 comprises a solar absorption device which is configured to collect solar energy and transfer this energy to steam flowing in the circuit 17 through the second superheater 22 to superheat the steam. For example, the solar absorption device used in this stage may be a so-called “power tower” or a parabolic trough collector.

The solar absorption device 32 in the heat transfer fluid portion 14 is configured to collect solar energy and transfer this energy to the heat transfer fluid flowing in the circuit 30 through the collector element. For example, the solar absorption device used in this stage may be a parabolic trough collector.

In operation of the solar power plant 10, a heat transfer fluid flowing in the circuit 30 is pressurized in the pressurizing device 34 to a pressure of for example 16-35 bar. Typically, the temperature of the HTF at this point in the cycle will be in the range of 150 to 350° C. From the pressurizing device 34, the heat transfer fluid is flowed in the circuit 30 through the solar absorption device 32 to heat the heat transfer fluid. The heat transfer fluid may be heated to a temperature of from 300 to 450° C. The heat transfer fluid is then flowed to the first superheater 100 where it makes thermal contact, for example in a heat exchanger with steam evolved in the boiler. The HTF is then flowed from the second superheater 100 to the boiler unit 20 for heat transfer contact with the feed water in the boiler to boil the feed water. The temperature of the HTF may for example be in the range of 260 to 430° C., depending on the degree of superheating performed in the first superheater 100. Thermal energy is transferred from the heated heat transfer fluid to the boiler feed water to convert the water to steam.

In the steam generating portion 12, boiler feed water discharged by the condensing turbine 16 may be at a temperature of 25 to 80° C. and a pressure of 0.03 to 0.57 bar (abs). The feed water is pressurized at pressuring device 24, for example to a pressure of 40 to 200 bar.

The pressurized feed water is fed in circuit 17 to the BFW heater 18, comprising a solar absorption device. In the solar absorption device, the boiler feed water is heated to a temperature below its boiling point.

Typically, the water is heated to a temperature of 250 to 365° C. and exits the BFW heater at this temperature, under essentially the same pressure applied to the feed water at pump 24.

The heated feed water is conveyed to the boiler 20 where it is brought into thermal contact with the heat transfer fluid, and vaporized to form saturated steam.

The steam from the steam boiler 20 is conveyed to the first superheater 100 where it is partially superheated to a temperature in the range of, for example, 260 to 375° C., at a pressure of 40 to 200 bar.

The partially superheated steam is then conveyed to the second superheater unit 22 where it is superheated in the solar absorption device. For example, the steam may be superheated to a temperature of 300 to 600° C., at a pressure of 40 to 200 bar.

From the second superheater 22, the superheated steam, under pressure, is conveyed to the condensing turbine 16 where it drives the turbine 16 in a manner known per se. The turbine 16 drives an electricity generator to generate power 52.

As mentioned, a heat storage medium circuit 38 is associated with the heat transfer circuit 14. At times of low demand, or when the sun's radiant energy is at a peak, the heat storage medium circuit 14 may be used to store excess thermal energy, which can be used at a later time of high demand or periods of darkness. In order to store thermal energy, the heated heat transfer fluid, or a portion of the heated heat transfer fluid is directed via passage 48 to the heat exchanger 44 where it gives up heat to the heat storage medium which is flowed through the heat exchanger from the cold tank 40 to the hot tank 42. As a result, the heat transfer fluid is cooled. In the embodiment shown, the heat transfer fluid still contains significant thermal energy and is flowed via passage 50 to the steam boiler 20 for thermal contact with the boiler feed water. At times when the energy input at the solar absorption device 32 is insufficient, the heat transfer fluid, or a portion of it, may be flowed through the heat exchanger via passage 46 and the storage medium simultaneously is flowed from the hot tank 42 to the cold tank 40. Heat is transferred from the hot storage medium to the heat transfer fluid, which flows on, via passage 50, to steam boiler 20. The temperature of the hot molten salt in the hot tank may be of the order of 430° C.

In night time operation, or where the solar radiant energy is inadequate, the solar absorption devices in the steam generation portion 12 may be by-passed, or partially by-passed and heating may be accomplished by conventional means. Thus, in the embodiment illustrated, the steam from steam boiler 20 is flowed via a branch passage 54 to the supplementary superheat furnace 26, which is fueled by a fossil fuel means, such as natural gas. The steam is superheated in the furnace and returned to the fluid circuit for supply to the turbine 16. Hot flue gases from the furnace, which may for example be at a temperature of 600 to 1000° C. are flowed from the furnace via passage 56a for thermal contact with the feed water in the steam generator 20 and further via passage 56b to the supplementary preheat device 28 through which the feed water is diverted by passage 58 for preheating. The cooled flue gas may be discharged directly to atmosphere.

Compared to current configurations the power plant illustrated in FIG. 1 may provide major capital cost savings (for example up to 10-15%). Further, reduced solar field heat losses (for example up to 5%) as well as increased turbine efficiency (for example of the order of 2-5%) may be provided. These outcomes may, for example, be achieved by matching the heat collector selection with three heating zones of pre-heat, boiling and superheat. Collectively these benefits significantly reduce the levalised cost of electricity (LCOE) produced in the Solar Power Plant

For instance, the application of linear Fresnel, with direct heating of the boiler feed-water may allow a lower capital cost collector to be used with a higher nett heat collection efficiency through the elimination of heat losses associated with the elevated temperature heat transfer loop. Further, parasitic pumping losses may be reduced in the pre-heating zone due to the lower mass flux of the boiler feed water vis a vis the heat transfer fluid. In addition, solar field start-up time may be reduced through the optimal heat transfer and mass flow properties of boiler feed-water at the start-up condition vis a vis heat transfer fluids.

In the boiling zone of the plant the required volume of heat transfer fluid may, for example, be reduced by approximately 30% yielding further capital cost savings. This zone of the heat transfer system typically requires provisions for thermal expansion that cause a significant potential loss of containment risk. By reducing the duty of this loop, the risk may be reduced by approximately 30%. Further, the duty curve (boiling, first stage superheating and heat storage) may be matched with the properties of higher performance Heat Transfer fluids (such as Silicones), whilst minimising the solar collector losses that would occur if the entire collector temperature was elevated.

Compared to current configurations the present invention may utilise the benefit of direct superheating in the collector, without heat transfer fluid limit, which may yield turbine efficiency improvements of up to 5%. The use of a “Power Tower” for the final superheating may result in a turbine inlet temperature and pressure condition of 550° C. and 100 Bar at a lower capital cost than current collector field costs. Similar savings may also possible in a trough collector.

The invention may also reduce the inventory of flammable or toxic heat transfer fluids by up to 40% and may reduce the number of potential release points, improving the environmental footprint of the solar power plant.

1. A method of generating superheated steam for use in power generation, comprising:
(a) preheating feed water to a temperature below its boiling point;
(b) boiling the preheated feed water to produce steam; and
(c) superheating the steam;
wherein the feed water is boiled by heat exchange with a heat transfer fluid which has been heated by heat collected in a first solar radiation absorption device;
and wherein one or other or both of the preheating and superheating is carried out by direct heating in at least one further solar radiation absorption device or devices.

2. A method according to claim 1, wherein the first solar radiation device comprises one or more trough solar absorption devices.

3. A method according to claim 1, wherein the preheating is carried out by direct heating in a second solar radiation absorption device and the superheating is carried out by direct heating in a third solar radiation absorption device.

4. A method according to claim 3, wherein the second solar radiation device comprises one or more linear Fresnel solar absorption devices.

5. A method according to claim 3, wherein the third solar radiation device comprises one or more tower solar absorption devices.

6. A method according to claim 3, wherein, prior to superheating the steam in the third solar radiation absorption device, the steam is superheated above the boiling point of the feed water by heat exchange with the heat transfer fluid.

7. A method according to claim 1, wherein the preheating is carried out by direct heating in a second solar radiation absorption device, and wherein the superheating is carried out by heat exchange with the heat transfer fluid.

8. A method according to claim 7, wherein the second solar radiation device comprises one or more linear Fresnel solar absorption devices.

9. A method of power generation comprising:
generating superheated steam by a method as claimed in claim 1; and
supplying the superheated steam to a turbine for power generation.

10. An apparatus for generating superheated steam for use in power generation, comprising:
(1) a superheated steam generating portion for generating superheated steam, comprising:
(a) a preheater zone for preheating a feed water to a temperature below its boiling point;
(b) a boiler zone downstream of the preheater zone for boiling the preheated feed water to produce steam; and
(c) a superheater zone downstream of the boiler zone, for superheating the steam; and
(2) a heat transfer fluid portion comprising a first solar radiation absorption device for heating a heat transfer fluid and being configured to transfer heat from the heated heat transfer fluid to the feed water in the boiler zone;
wherein one or other of the preheater zone and the superheater zone comprises a further solar radiation absorption device for direct heating of the feed water or the steam, or wherein each of the preheater zone and the superheater zone comprises a further solar radiation absorption device for direct heating respectively of the feed water and the steam.

11. An apparatus according to claim 10, wherein the first solar radiation device comprises one or more trough solar absorption devices.

12. An apparatus according to claim 10, wherein the preheater zone comprises a second solar radiation absorption device for direct heating of the feed water and the superheater zone comprises a third solar radiation absorption device for direct heating of the steam.

13. An apparatus according to claim 12, wherein the second solar radiation device comprises one or more linear Fresnel solar absorption devices.

14. An apparatus according to claim 12, wherein the third solar radiation device comprises one or more tower solar absorption devices.

15. An apparatus according to claim 12, wherein the heat transfer fluid portion is further configured to transfer heat from the heated heat transfer fluid to the steam downstream of the boiler zone and upstream of the third solar absorption device, whereby the steam is superheated above the boiling point of the feed water by heat exchange with the heat transfer fluid prior to being superheated in the third solar absorption device.

16. An apparatus according to claim 10, wherein the preheater zone comprises a second solar radiation absorption device for direct heating of the feed water and wherein the heat transfer fluid portion is further configured to transfer heat from the heated heat transfer fluid to the steam in the superheater zone, whereby the steam is superheated above the boiling point of the feed water by heat exchange with the heat transfer fluid.

17. An apparatus according to claim 16, wherein the second solar radiation device comprises one or more linear Fresnel solar absorption devices.

18. A method of generating superheated steam for use in power generation using the apparatus of claim 10, comprising:
(a) preheating feed water in the preheater zone to a temperature below its boiling point;
(b) boiling the preheated feed water in the boiler zone to produce steam; and
(c) superheating the steam in the superheater zone;
wherein the feed water is boiled in the boiler zone by heat exchange with the heat transfer fluid which has been heated by heat collected in the first solar radiation absorption device;
and wherein one or other or both of the preheating and superheating is carried out by direct heating in at least one further solar radiation absorption device.

19. A solar power plant comprising:
an apparatus for generating superheated steam according to claim 10; and
a turbine configured to receive superheated steam from the apparatus for generating superheated steam and capable of power generation.

20. A method of operating a solar power plant as claimed in claim 19, comprising:
heating a heat transfer fluid in the first solar radiation absorption device of the heat transfer fluid portion;
generating superheated steam from a feed water in the superheated steam generating portion; and
supplying the superheated steam to the turbine for power generation,
wherein the superheated steam for supply to the turbine is generated from the feed water in at least three heating stages comprising:
(a) a preheating stage in which the feed water is preheated in the preheater zone to a temperature below its boiling point;
(b) a boiling stage in which the preheated feed water is boiled in the boiler zone to produce steam; and
(c) a superheating stage in which the steam is superheated in the superheater zone;
wherein the feed water is boiled in the boiler zone by heat exchange with the heat transfer fluid which has been heated by heat collected in the first solar radiation absorption device;
and wherein one or other or both of the preheating and superheating is carried out by direct heating in at least one further solar radiation absorption device.

21. (canceled)
